(19) United States
(12) Patent Application Publication
(10) Pub. No.: US 2017/0312813 A1
(43) Pub. Date: Nov. 2, 2017

(54) CASTING METHOD OF USING 3D PRINTING TO MAKE SHELL MOLD AND VACUUM CASTING DEVICE FOR USE IN THE CASTING METHOD

(71) Applicant: Cheng-Kuan Wu, Taipei (TW)

(72) Inventor: Cheng-Kuan Wu, Taipei (TW)

(21) Appl. No.: 15/143,637

(22) Filed: May 2, 2016

(51) Int. Cl. B22C 13/08; B22C 1/22; B22C 9/02; B22C 9/12; B28B 1/00; B33Y 10/00; B33Y 30/00

(52) U.S. Cl. CPC B22C 13/08; B22C 9/02; B22C 1/22; B22C 9/12; B33Y 10/00; B33Y 30/00; B28B 1/001

(57) ABSTRACT

A casting method of using 3D printing to make shell mold, comprising the following steps of: conducting computer-aided graphic design based on the product to be manufactured; importing the graphic design into the 3D printer to print a 3D shell mold; conducting a sintering process of the printed shell mold for solidifying thereof; using the sintered shell mold as a casting cavity, injecting a molten raw material into the shell mold for formation; in the end, taking out the whole shell mold and breaking the shell mold to obtain a cast product; reprocessing the cast product to obtain a finished product; wherein printing materials of the 3D printing are made of a liquid mixture of photosensitive resin and ceramic powder, thereby improving production efficiency and reducing labor intensity as well as pollution.

### FIELD OF THE INVENTION

The present invention relates generally to a technical field of lost wax casting, more particularly to a casting method of using 3D printing to make shell mold and vacuum casting device for use in the casting method.

### BACKGROUND OF THE INVENTION

Lost wax casting is one kind of precision casting. Its production technique is as follows:

1. Make a graphic design based on the product to be manufactured, and make a mold based on the graphic design.

2. Using the mold, make a wax model through injection molding, and correct the wax model.

3. Assemble several wax models into a wax tree, so as to cast several products all at once and improve working efficiency.

4. Conduct dip-coating so that the wax tree is coated with a layer of slurry. When the slurry is dry, repeat the dip-coating for multiple times. To ensure appropriate thickness of the slurry shell mold, the dip-coating shall generally be carried out for 5-6 times. Thickness of the shell mold shall reach 5-7 mm.

5. After dip-coating, conduct steam dewaxing so that the wax model inside the shell mold can flow out, and the wax model is separated from the shell mold.

6. After dewaxing, the shell mold shall be sintered, so that the slurry to form the shell mold is solidified, and the wax model residuals are completely burnt out.

7. The sintered shell mold is used as the cavity for casting. Molten raw material (e.g., molten metal, glass etc) are injected into the shell mold for casting. In the end, the whole shell mold is taken out. Break the shell mold to obtain the cast product.

8. Carry out post-processes, such as sand cleaning, shot blasting etc to obtain the finished product.

From the above, it is known that the existing lost wax casting technique is very complicated. Moreover, the sintering and sand cleaning processes will cause pollution. Meanwhile, production of the shell mold is also very complicated, leading to a direct result of low production efficiency.

On the other hand, 3D printing technique is developing rapidly, and is now applied in various fields. 3D printing is basically a rapid prototyping technique. Its working processes are as follow: Firstly, use a computer modeling program to establish a 3D model. Then, partition the model into slices and instruct the printer to print layer after layer. Pile up the thin layers to form a solid object. The biggest difference between a multifunctional 3D printer and a traditional printer is: the “ink” used by the former is concrete raw material. Normally, the raw material is hot melting adhesive lines, wax etc. Insert the tip end of the hot melting adhesive line into the hot melting printing head of the 3D printer. When powered on, the hot melting printing head will heat the hot melting adhesive line to melt it. The molten adhesive will flow out from the lower end of the printing head. Printing is done layer after layer, and the thin slices are piled up to form a solid object.

Recently, 3Dceram, a company in Limoges, France developed an industrial 3D printer named Ceramaker. The Ceramaker 3D printer uses a totally new 3D printing technique called CAM (Ceramics Additive Manufacturing). This technique is based on research in the application of laser curing technology, published on SPCTS (Science des Procédés Céramiques et de Traitements de) in Limoges by Thierry Chartier in 1998. His research results were adopted by 3DCeram Company, and the company carried out more in-depth research and development and applied the technique in various fields. This technique adopts a mixture of photosensitive resin and ceramic powder. The liquid mixture is laser printed and cured. Thickness of layer can reach 25-100 um. Each layer is attached to the former layer through UV curing to finally form a 3D printed object. In the final post-processing stage, continuous sintering is carried out. According to the data provided by 3DCeram, in the CAD file, the size of the object is adjusted based on the shrinking percentage during the sintering process. Suitable materials include aluminium oxide, zirconium oxide and hydroxylapatite/tricalcium phosphate. These materials require light-resistant packaging and storage at room temperature. Current applications of the technology of 3DCeram include biomedical transplantation, jewelry manufacturing, and advanced high-precision industrial prototype designing.

After continuous research and experiments, the inventor of the present invention introduced 3D printing technique into the lost wax casting field, and proposed the following technical solution.

### SUMMARY OF THE INVENTION

The present invention combines tradition lost wax casting and 3D printing technology to provide a casting method of using 3D printing to make shell mold for solving the problems of the prior art.

For solving the above mentioned problems, the present invention provides the following technical scheme: the casting method of using 3D printing to make shell mold, comprising the following steps of: (1) conducting computer-aided graphic design based on the product to be manufactured; (2) importing the graphic design into the 3D printer to print a 3D shell mold; (3) conducting a sintering process of the printed shell mold for solidifying thereof; (4) using the sintered shell mold as a casting cavity, injecting a molten raw material into the shell mold for formation; in the end, taking out the whole shell mold and breaking the shell mold to obtain a cast product; (5) reprocessing the cast product to obtain a finished product; Wherein printing materials of the 3D printing are made of a liquid mixture of photosensitive resin and ceramic powder.

Furthermore, wherein the ceramic powder in the printing material comprises: aluminium oxide, zirconium oxide, hydroxylapatite or tricalcium phosphate.

Furthermore, wherein the thickness of the printed shell mold is 0.1-2 mm.

After adopting the above mentioned technical scheme, the shell mold is directly produced by 3D printing, so that the manufacturing process is decreased and the manufacturing effect is improved.

Another problem to be solved is to provide a vacuum casting device for use in the casting method.

Compared to prior art, the advantages of the present invention is the shell mold can directly print out the shell mold through a 3D printer, and thus omitted the shell mold production processes in the conventional technique, and consequently improved production efficiency and reduced labor intensity as well as pollution.

### BRIEF DESCRIPTION OF THE DRAWINGS

FIG. 1 is a schematic view of a cast device of the present invention.

### DETAILED DESCRIPTION OF THE PREFERRED EMBODIMENTS

Below are further descriptions of the present invention with reference to the detailed embodiments and accompanying drawings.

The method of the present invention comprises the following steps:

1. Conduct computer-aided graphic design based on the product to be manufactured, normally using a graphics software program that can output to a 3D printer.

2. Input the graphic design into the 3D printer to print a 3D shell mold. The 3D printing mentioned in the present invention differs from traditional 3D printing in that it does not use hot melting material for direct printing and curing. The printing material adopted by the present invention uses a liquid mixture of photosensitive resin and ceramic powder. The printing method is the same as the current method, i.e., partitioning into “slices” and printing layer after layer. The thickness of each printed layer is 25-100 um. Upon completion of printing, each layer shall undergo UV radiation, so that the photosensitive resin is cured, and meanwhile the ceramic powder material is solidified to form the casting. After such printing and light curing layer after layer, a 3D printed shell mold is finally obtained. The ceramic powder in the printing material include: aluminium oxide, zirconium oxide, hydroxylapatite, tricalcium phosphate, or mullite powder. Final thickness of the printed shell mold is 0.1-2 um.

3. Sinter the shell mold to solidify the printed shell mold. Although the shell mold printed by the 3D printer is solid, it is only bonded by photosensitive resin material, and can not be used directly in the casting process. Sintering shall be adopted to burn and remove the resin in the printed shell mold and cure the ceramic material, so as to obtain a shell mold for casting.

There are two sintering methods. One is to directly sinter the printed shell mold. This method is the same as the sintering method in existing casting technique, just requiring appropriate adjustment of the temperature and time. The other method is to directly use the Ceramaker 3D printer produced by 3DCeram, which can directly and continuously sinter the printed shell mold using laser.

4. Use the sintered shell mold as the cavity for casting, inject molten raw material for casting in the shell mold. In the end, take out the whole shell mold, and break the shell mold to obtain the cast product.

In this step, because the 3D printed shell mold can not withstand direct pouring of molten metal material, the shell mold shall be buried in sand. That means, bury the shell mold in a molding flask, reserve the pouring gate, and vibrate the molding flask so as to tighten the sand outside the shell mold. Then carry out pouring and casting. After casting, take out the whole shell mold from the molding flask, and break the shell mold to obtain the cast product.

5. Carry out post-processes to obtain the finished product.

The cast product shall undergo post-processes, such as shot blasting, to finally obtain the finished product.

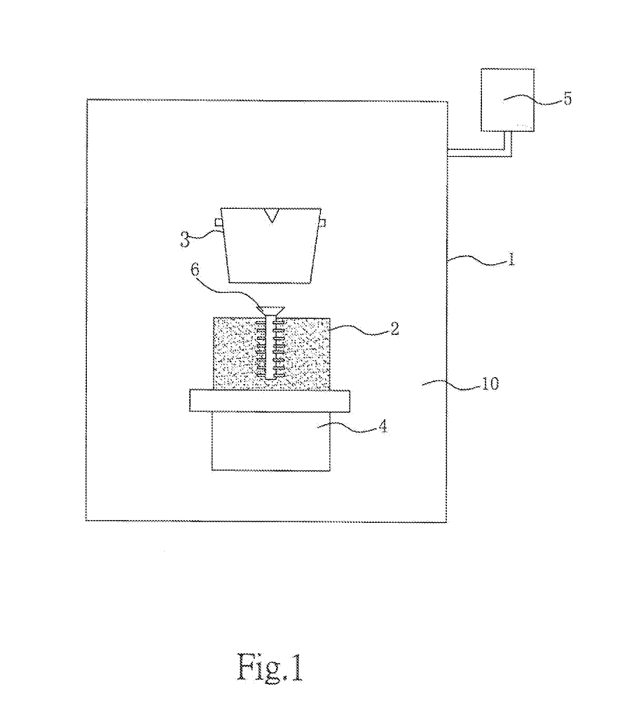

In the above embodiment, during pouring and casting, to avoid defects like bubbles in the cast product, the whole pouring and casting process shall be carried out in a vacuum environment. Referring to FIG. 1, the pouring and casting device used by the present invention includes: a sealed chamber, inside which a molding flask is placed, and an electric furnace to melt metal. The molding flask is placed on a vibration device. The chamber is connected to a vacuum pump, which is used to evacuate the chamber. In operation, the shell mold is buried in a molding flask, reserve a pouring gate, and vibrate the molding flask to tighten the sand outside the shell mold. In the end, close the chamber, and evacuate the chamber, so that the closed space inside the chamber is under a negative pressure state. Then carry out pouring and casting. After casting, take out the whole shell mold from the molding flask, and break the shell mold to obtain the cast product.

The printing material adopted by the present invention uses a liquid or paste-like mixture of photosensitive resin and ceramic powder. The photosensitive resin is made of resin monomer and oligomer, containing active functional groups. Under UV radiation, the light initiator will initiate a polymerization reaction to form solid substance. In simple terms, the photosensitive resin is so-called UV resin, which is cured under UV radiation. The photosensitive resin is normally liquid, and can be generally used in a SLA printer (3D light curing prototype printer). The present invention uses photosensitive resin to form a rough shape of the shell mold, actually the shell mold material is formed by ceramic slurry after continuous dipping, drying and sintering.

To prepare the printing material used in the present invention, firstly prepare ceramic powder material. Typical ceramic powder materials include: aluminium oxide, zirconium oxide, hydroxylapatite, tricalcium phosphate, or mullite powder. Then add photosensitive resin, and mix them thoroughly to form a liquid or paste-like mixture, to be used as the printing material. The weight ratio between the ceramic powder material and photosensitive resin is: ceramic powder 60-90%, photosensitive resin: 10-40%.

To facilitate formation of the product during printing, the percentage of photosensitive resin can not be too low. If it is too low, the printed shell mold can not be firmly bonded by the photosensitive resin to form the shape, and collapse may easily happen. If the percentage of photosensitive resin is too high, during final sintering, formation of the ceramic powder will become difficult, or the formed product will have a rough surface.

In addition, to facilitate formation during printing, other hot melting resin materials, like ABS, nylon etc, can be added, so that the product is more easily formed during printing.

During pouring and casting, to avoid defects like bubbles in the cast product, the whole pouring and casting process shall be conducted in a vacuum environment.

During pouring and casting, to avoid defects like bubbles in the cast product, the whole pouring and casting process is conducted in the vacuum closed space (10) of a vacuum box (1). The closed space (10) is connected to a vacuum pump 5, which evacuate the closed space (10). In operation, the shell mold 6 is buried in the molding flask (2), reserve the pouring gate, and vibrate the molding flask (2) through the vibration device (4), so as to tighten the sand outside the shell mold (6). In the end, close the closed space 10, and evacuate the closed space (10), so that the closed space (10) is under a negative pressure state.

When casting, direct activate the electric furnace (3) to rotate, and pour molten raw material into the corresponding shell mold (6). When casting is completed, take out the whole shell mold 6 from the molding flask (2), and break the shell mold (6) to obtain the cast product.

The present invention also covers the above-mentioned vacuum casting device. When casting, bury the shell mold (6) in the molding flask (2), vibrate the molding flask (2) through the vibration device (4), so as to tighten the sand outside the shell mold (6). The foundry sand inside the molding flask provides a support to the periphery of the shell mold (6). As the shell mold (6) is printed by a 3D printer, its thickness is very low. With the sand providing a tight outside support, the shell mold (6) will not break during pouring and casting, and therefore the whole casting process can be completed without failure.

### DETAILED DESCRIPTION OF THE INVENTION

Below is a comparison between the present invention and the existing conventional casting technique:

Based on a monthly production output of 50 tons, numbers of workers and managers to be used by the two casting methods are compared:

| | Conventional lost wax | 3D printed shell mold |
|---|---|---|
| Workers and managers | casting method | casting method |
| Shell mold (including | 60 persons | 10 persons |
| wax injection, wax | | |
| correction, and wax | | |
| tree assembly) | | |
| Pouring | 10 persons | 8 persons |
| Shot blasting (include | 8 persons | 4 persons |
| sand removal) | | |
| Product inspection and | 42 persons | 26 persons |
| warehouse entry | | |
| Indirect managers | 20 persons | 30 persons |
| Total | 140 persons | 78 persons |

With the conventional lost wax casting method as basis, the technical data of production between the two casting methods are compared:

| | Conventional lost wax | 3D printed shell mold |
|---|---|---|
| | casting method | casting methods |
| Electric Power | 100% | 70% |
| Labor | 100% | 58% |
| Material | 100% | 50% |
| Site area | 100% | 60% |
| Pollution | 100% | 10% |

From the above comparisons, it is known that, by adopting the above technical scheme, the present invention can directly print out the shell mold through a 3D printer, and thus omitted the shell mold production processes in the conventional technique, and consequently improved production efficiency and reduced labor intensity as well as pollution.

I claim:

1. A casting method of using 3D printing to make shell mold, comprising the following steps of:
(1) conducting computer-aided graphic design based on the product to be manufactured;
(2) importing the graphic design into the 3D printer to print a 3D shell mold;
(3) conducting a sintering process of the printed shell mold for solidifying thereof;
(4) using the sintered shell mold as a casting cavity, injecting a molten raw material into the shell mold for formation; in the end, taking out the whole shell mold and breaking the shell mold to obtain a cast product;
(5) reprocessing the cast product to obtain a finished product;
wherein printing materials of the 3D printing are made of a liquid mixture of photosensitive resin and ceramic powder.

2. The casting method defined in claim 1, wherein the ceramic powder in the printing material comprises: aluminium oxide, zirconium oxide, hydroxylapatite or tricalcium phosphate.

3. The casting method defined in claim 1, wherein the thickness of the printed shell mold is 0.1-2 mm.

4. The casting method defined in claim 1, wherein the sintering process in step 3 is used by a continuous laser sintering.

5. The casting method defined in claim 1, wherein the shell mold has following steps to undergo sand burying prior to the casting in step 4: bury the shell mold in a molding flask, reserve a pouring gate, vibrate the molding flask to tighten sands outside the shell mold, and then conduct the casting.

6. The casting method defined in claim 5, wherein the casting in step 4 is conducted in a vacuum or a negative pressure environment.

7. A vacuum casting device used by a casting method of using 3D printing to make shell mold, comprises: a vacuum box (1) having a closed closed space (10), the closed closed space (10) having a molding flask (2) and a rotatable electric furnace (3); a pump (5) disposed outside the closed closed space (10) configured to pump air;
wherein the closed closed space (10) comprises a vibration device (4) installed therein, the molding flask (2) being placed on the vibration device (4); a 3d printed shell mold (6) buried inside the molding flask (2); the vibration device (4) is configured to vibrate and tighten sands outside the shell mold (6);
wherein the shell mold (6) reserves a pouring gate exposed above a surface of the the molding flask (2) corresponding to an exit of the electric furnace (3); after rotation, the electric furnace (3) pours molten raw material into the pouring gate of the shell mold (6).
